(19) United States
(12) Patent Application Publication
(10) Pub. No.: US 2009/0045572 A1
(43) Pub. Date: Feb. 19, 2009

(54) Educational Board Game and Method of Use

(76) Inventor: Wendell L. Teal, South Euclid, OH (US)

Correspondence Address: T.L. GARRETT, PLC, P.O. BOX 1065, FENTON, MI, 48430, US

(21) Appl. No.: 12/224,921

(22) PCT Filed: Oct. 24, 2007
(86) PCT No.: PCT/US07/22562

§ 371 Date: Sep. 9, 2008

Related U.S. Application Data
(63) Continuation of application No. 11/725,117, filed on Mar. 16, 2007, now abandoned.
(60) Provisional application No. 60/854,308, filed on Oct. 25, 2006.
(60) Provisional application No. 60/854,308, filed on Oct. 25, 2006.

(51) Int. Cl. A63F 3/00; G09B 19/22

(52) U.S. Cl. 273/243; 434/128

(57) ABSTRACT

A board game and method of use simulates an experience of school in the structure, layout, and the educational materials. The game includes a map imprinted on a board that simulates an interactive school environment having associated spaces representing classrooms and actions to be taken by students or players represented by associated player pieces of the game. Additional player pieces include staff members of the school. A wheel and spinner is provided to determine a number of spaces a player may advance each turn. A plurality of flash cards are provided that provide associated educationally related questions that may be answered through use of a decipher code. Answers are checked and the game administrative rules are administered by a class monitor operating through use of a class monitor workstation. A diploma is awarded to students who have earned a predefined number of points necessary to graduate the school.

### CROSS-REFERENCE TO RELATED APPLICATION

The present PCT application claims priority benefit of U.S. Non-Provisional patent application Ser. No. 11/725,117, filed Mar. 16, 2007, titled “EDUCATIONAL BOARD GAME AND METHOD OF USE”, the disclosure of which is incorporated herein by reference in its entirely, which claims priority benefit of U.S. Provisional Patent Application No. 60/854,308, filed October 25, titled “EDUCATIONAL BOARD GAME AND METHOD OF USE”, the disclosure of which is incorporated herein by reference in its entirety.

### FIELD OF THE INVENTION

The present invention generally relates to an educational game for use in the field of interactive and school simulative board games.

### BACKGROUND

The use of devices and methods relating to an educational board game are disclosed in U.S. Pat. No. 4,714,254 issued in the name of Calloway (CALLOWAY). CALLOWAY discloses an educational board game and method of use wherein the game is configured so as to simulate education at a high school or collegiate level.

CALLOWAY discloses a game consisting of two groups of several spaces arranged on a board, a spinner, cards containing questions, and two playing pieces per player.

Each of the inner spaces on the board represents a class. The outer spaces of the board correspond to various actions that a player must take upon landing on one; some of the outer spaces contain questions pertaining to the classes.

In order for a player to pass a class, the player must answer all of the questions that are related to that class. The player's progress is monitored by the position of their respective playing piece on the inner space. To win the game, a player must pass all of the classes.

The players move their respective pieces around the board according to what they spin on a spinner that is included with the game. The spinner is also used to determine which of the players will play first.

The use of devices and methods relating to an educational board game are disclosed in U.S. Pat. No. 6,224,056 issued in the name of Jones (JONES).

JONES discloses a board game wherein the purpose of the board game is to reinforce the occupational skills and knowledge of the players.

JONES discloses a board game that consists of a board having several spaces arranged in a boundary and spoke configuration, a plurality of playing pieces, cards containing questions and answers, and a chance means for determining movement of the playing pieces on the board.

The use of devices and methods relating to an educational board game are disclosed in U.S. Pat. No. 5,749,580 issued in the name of Lopez (LOPEZ).

LOPEZ discloses an educational board game specifically related the teaching of skills and knowledge relevant to a driver's license exam. The players move their pieces around the board and answer questions pertaining to traffic safety, rules of the road, and driving under the influence. Each question correctly answered give the player answering a particular number of points. The first player that reaches a predetermined number of points is the winner.

The use of devices and methods relating to an educational board game are disclosed in U.S. Pat. No. 4,955,616 issued in the name of Ingalls (INGALLS). INGALLS discloses a board game wherein the game is intended to imitate the common experiences of people as they live life. The game includes a portion that is related to education. There is no requirement for players to answer any type of question or to exhibit any knowledge when their playing piece lands upon one of the educational spaces. Instead, the players must pay a predefined sum of play money to simulate the expense of education.

The use of devices and methods relating to an educational board game are disclosed in U.S. Pat. No. 5,007.650 issued in the name of Reed et al. (REED).

REED discloses a board game that focuses on the non-academic aspects of the college lifestyle. The central focus of the game is social drinking, and the game does not require any questions to be answered in order for the players to advance.

While existing devices suit their intended purpose, the need remains for a device and method that is simulative of the experience of school in the structure, layout, and the educational materials.

### SUMMARY

The present invention provides a board game that is simulative of the experience of school in the structure, layout, and the educational materials. The game includes a map imprinted on a board that simulates an interactive school environment having associated spaces representing classrooms and actions to be taken by students or players represented by associated player pieces of the game. Additional player pieces include staff members of the school. A wheel and spinner 0 is provided to determine a number of spaces a player may advance each turn. A plurality of flash cards are provided that provide associated educationally related questions that may be answered through use of a decipher code. Answers are checked and the game administrative rules are administered by a class monitor operating through use of a class monitor workstation. A diploma is awarded to students who have earned a predefined number of points necessary to graduate the school. A method of using the game is also provided.

### BRIEF DESCRIPTION OF THE DRAWINGS

These and other objects, features and advantages of the present invention will become apparent from the following detailed description and the appended drawings in which:

FIG. 1 illustrates a top view of a board game imprinted with a map of a school in accordance with one aspect embodiment of the invention.

FIGS. 1A-1D each illustrate a sectional top view of the board game imprinted with a map of a school illustrated in FIG. 1, in accordance with one aspect embodiment of the invention.

FIG. 2 illustrates a representation of the board game shown in FIG. 1 including numbered spaces associated with each space on the map in accordance with one embodiment of the technology.

FIG. 3 illustrates an inner maze portion of the map shown in FIG. 2.

FIG. 4 illustrates a top view of a board game in accordance with one embodiment of the invention.

FIG. 5 illustrates a top and a bottom view of a plurality of hall pass flash cards and a class room monitor portion in accordance with one embodiment of the invention.

FIG. 6 illustrates a top and bottom view of a representative number of a plurality of hall pass flash cards in accordance with one embodiment of the invention.

FIG. 6A illustrates a top and bottom view of a representative number of a plurality of hall pass flash cards in accordance with one embodiment of the invention.

FIG. 7 illustrates a table of a deciphering code in accordance with one embodiment of the invention.

FIG. 8 illustrates an answer guide for answers to questions and clues associated with each hall pass flash card in accordance with one embodiment of the invention.

FIG. 9 illustrates a front cover of the guide shown in FIG. 8.

FIG. 10 illustrates a back cover of the guide shown in FIG. 8.

FIG. 11 illustrates a plurality of player pieces representing staff members of a school in accordance with one embodiment of the invention.

FIG. 12 illustrates a plurality of player pieces representing students and a class monitor of a school in accordance with one embodiment of the invention.

FIG. 13 illustrates a top view of a wheel spinner in accordance with one embodiment of the invention.

### DETAILED DESCRIPTION OF THE INVENTION

An educational board game operates to enrich and enhance a player such as a student's academic aptitude in all subject areas of education. The game may be used recreationally by any players and may prove particularly useful in numerous school settings, i.e. after school programs, summer school programs, public and private schools, home schools or adult education classes. As defined herein a player may be any individual participating in the game including, but not limited to a student, a parent, or a teacher. The terms “player”, “student”, and “participant will be used interchangeably herein.

In operation, the board game allows players to answer trivia questions in various school subjects to gain points. The game is intended to provide an enjoyable game that may be played for friendly competition and entertainment. The game is both lightweight and portable and may prove ideal for parties and get-togethers. The game may be used by anyone and may particularly suitable for families and schools for all ages, including adult education classes.

The game represents a simulative school for students ranging from about the fourth grade to high school and beyond, challenging and enhancing a student's academic ability. The questions and answers are geared toward four subjects that are currently taught in all schools throughout the United States. The subjects are math, English, U.S. History and science. Also included are the library, Spanish class, music class and computer class. All of the classes are primary subjects that coincide with what is taught in all school systems nationally. However, it is contemplated that the game may be adapted for use by players of all ages.

Teachers, guest teachers and elementary school counselors may use the board game as a way of enhancing learning to be fun and meaningful. Parents may also use it in lieu of television to prepare their children for class work. The game is engaging and applicable to a student's daily journey throughout his or her life in school.

An educational board game includes:

a map imprinted on a game board that simulates an experience of a school including an operational structure, a physical layout and associated educational materials associated with the school. The map has a first set of squares representing a plurality of classrooms in a school; and a second set of squares representing a plurality of non-classrooms associated with actions to be taken by players landing on the second set of squares.

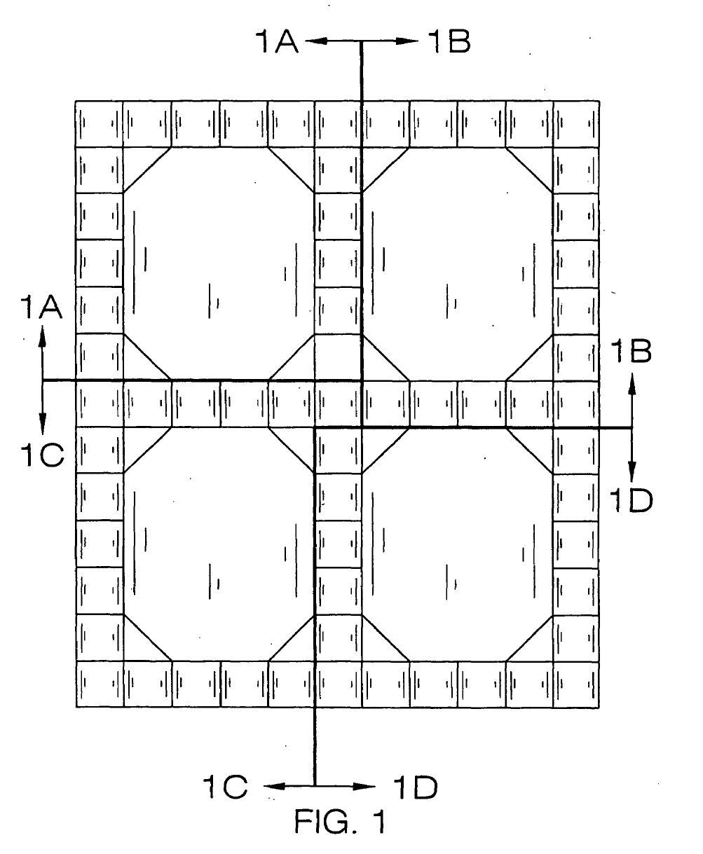

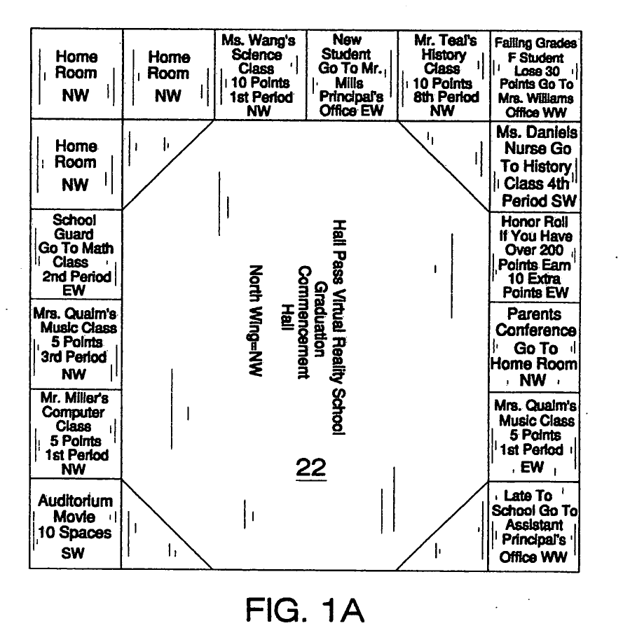

FIG. 1 illustrates a top view of a layout of the board game 20 in accordance with one embodiment of the invention.

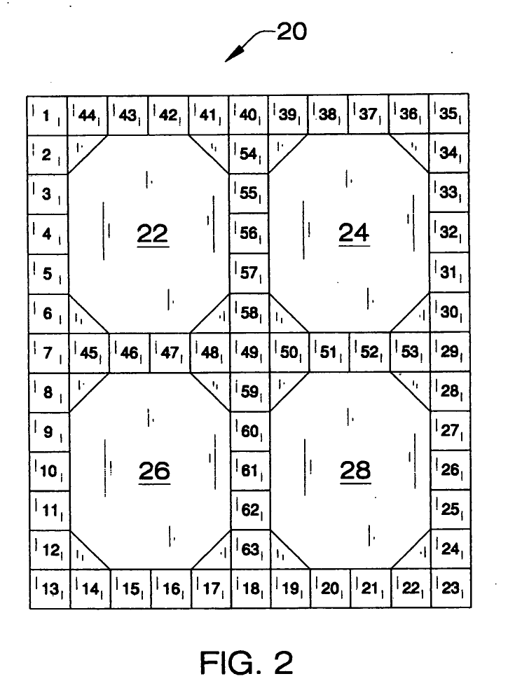

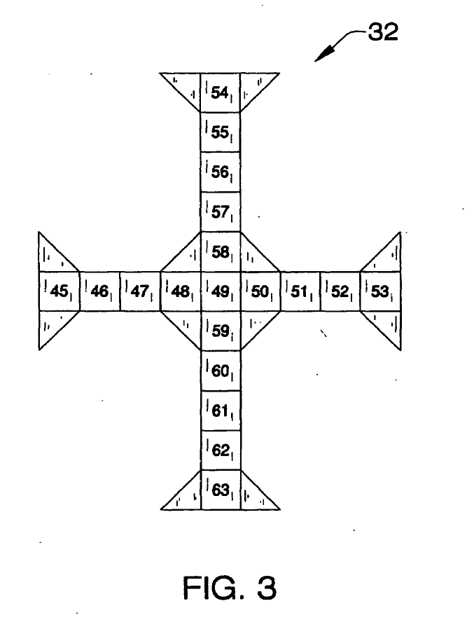

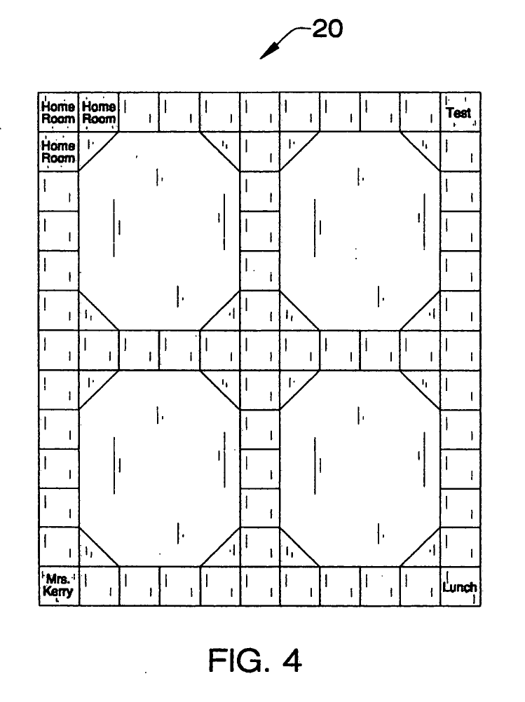

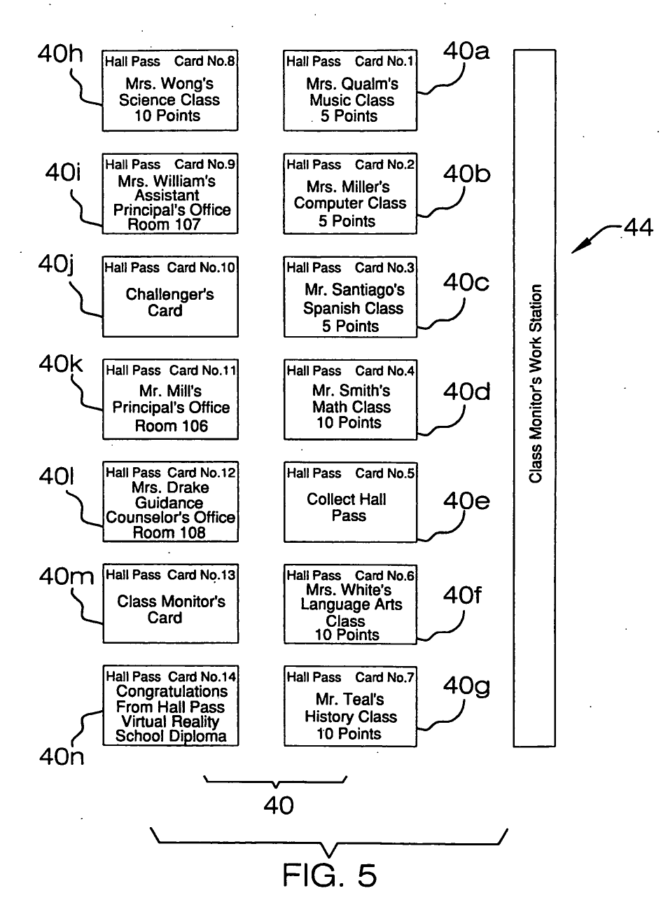

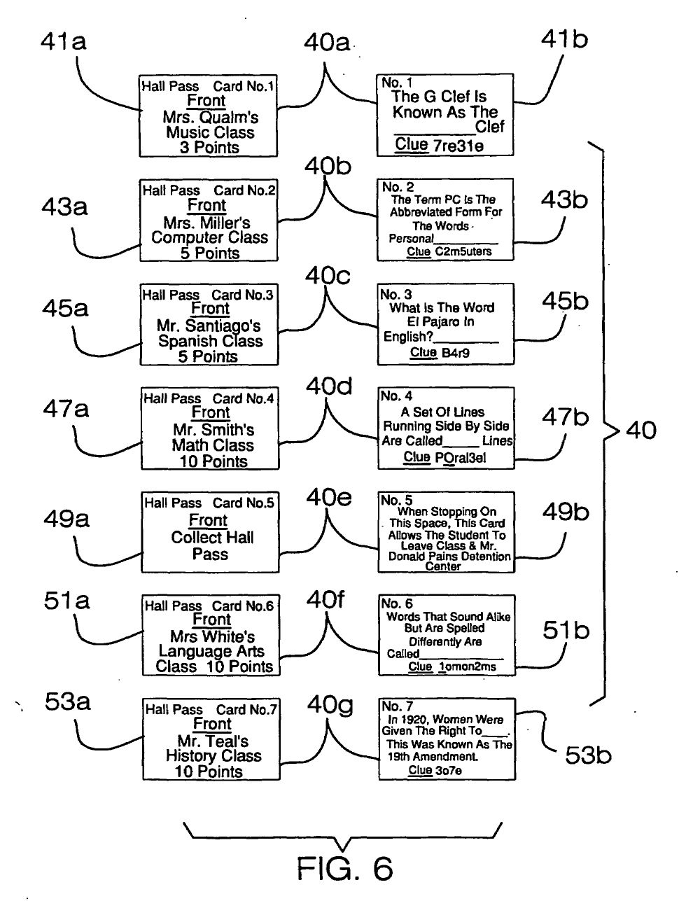

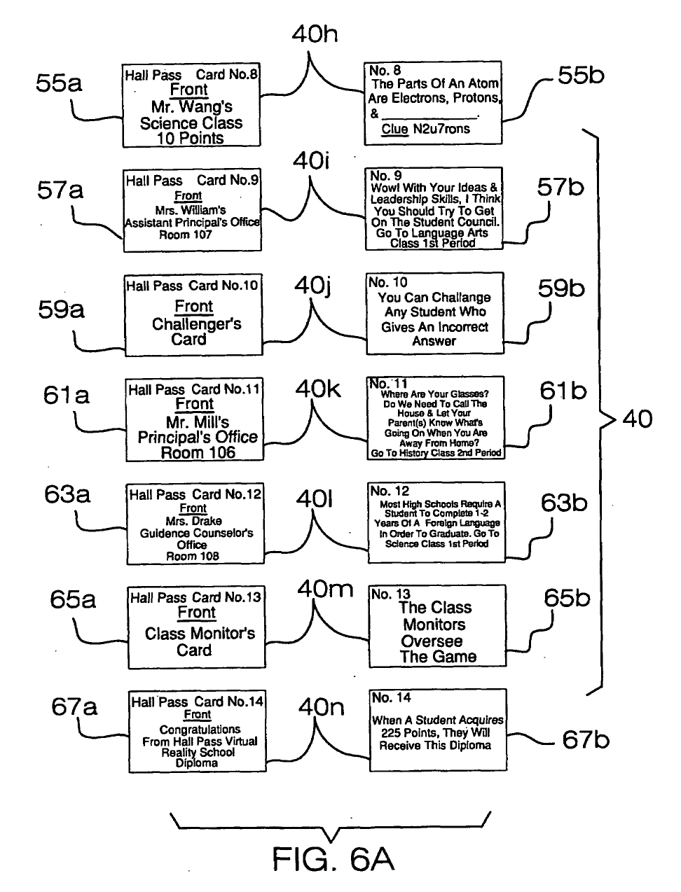

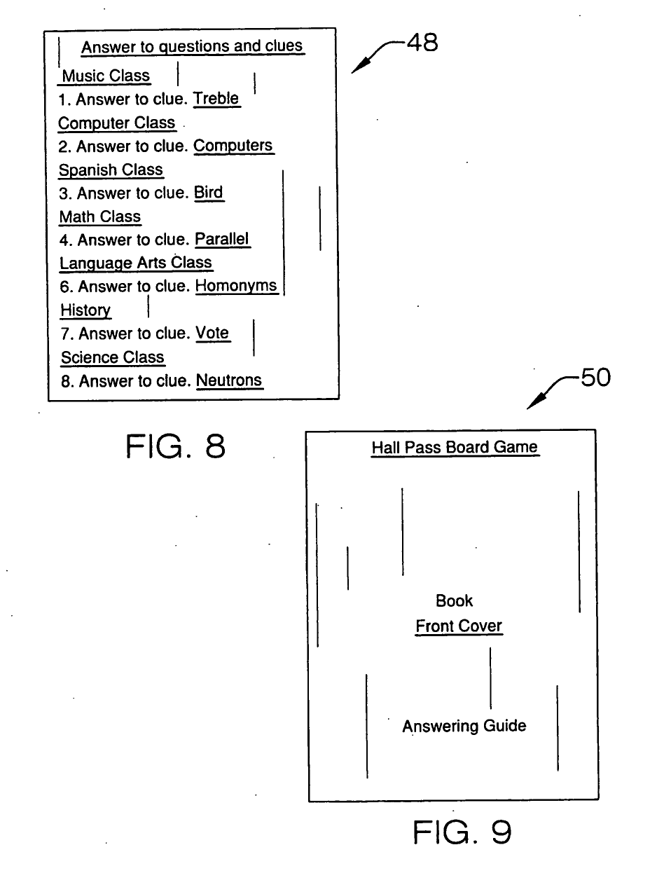

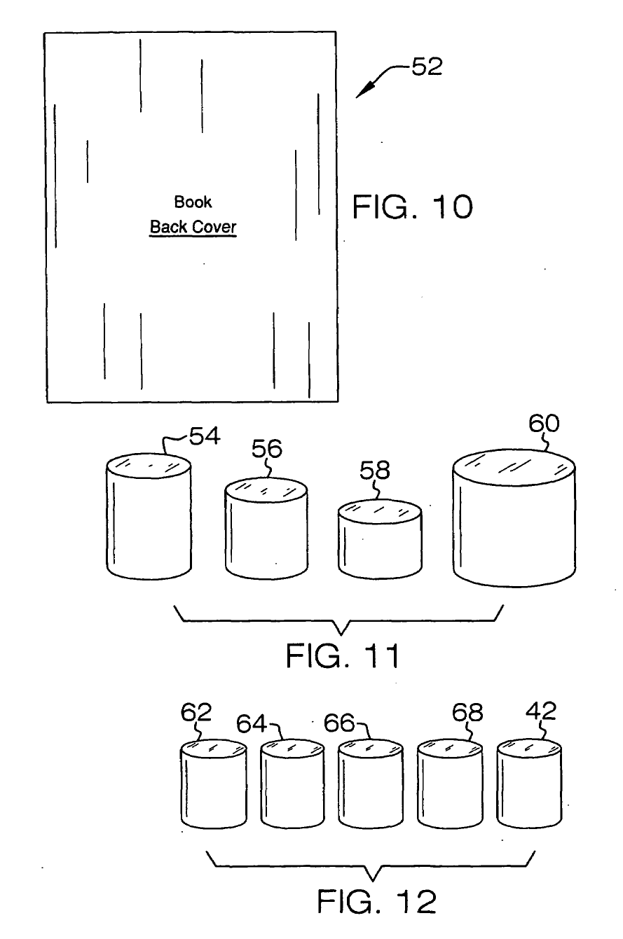

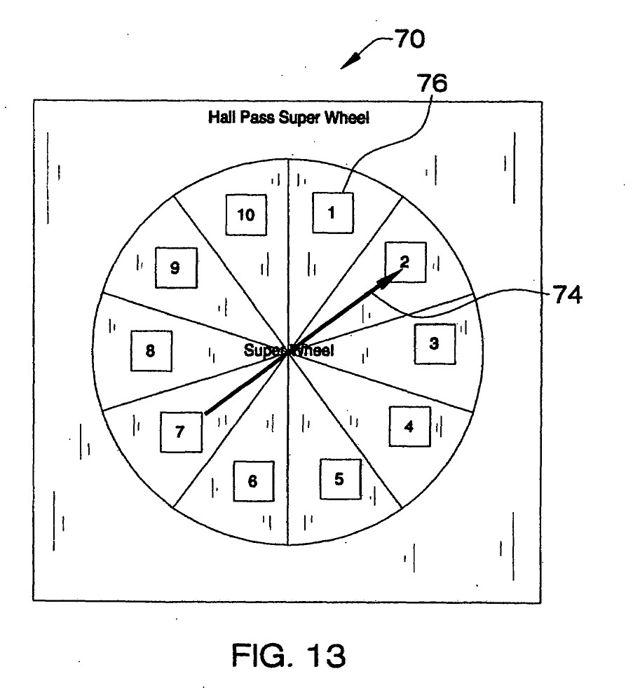

The game includes a game board (shown in FIGS. 1-4), a spinner (shown in FIG. 13), player pieces (shown in FIGS. 11-12), a classroom monitor portion (shown in FIG. 5), deciphering codes (shown in FIG. 7), game cards (shown in FIGS. 6 and 6A), and an answering guide 48 having a front and back cover 50, 52 respectively associated with the game cards (shown in FIGS. 8-10).

In one embodiment of the invention, the board is imprinted with a map of a school in four quadrants 22, 24, 26, and 28, respectively, representing four wings of the school, illustrated in FIGS. 1A-1D.

Movement spaces 30 are marked on paths around the school and are imprinted with classroom type and teacher name. A maze 32 is imprinted in a criss-cross tee configuration in an inner perimeter of the school to specify actions that are taken when landing on each space within the maze 32. The maze 32 includes spaces that awards or subtract points or moves the players on the board.

The game 20 includes question cards 40 or “hall pass flash cards” in subjects such as math, English, history, science, Spanish, music and computer skills.

To play, one player may be designated as a Class Monitor 42, wherein the class monitor has an associated class monitor workstation 44 (shown in FIG. 5) adapted to organize a plurality of flash cards 40. The class monitor 42 sets up the game board and is in charge of reading associated questions. On each turn, a player spins the spinner 74, and moves a corresponding number of spaces. The player then follows the instructions printed on the space. If the player lands on a question space, the player must answer a question in the corresponding subject and then earns points for a correct answer.

In another embodiment of the invention, there may be more than one class monitor. More than one user may serve as a class monitor in this embodiment.

In one embodiment of the invention the answers to the questions may be encoded using a special game cipher called a deciphering code 46, shown in more detail in FIG. 7. The game continues in this manner until one player or team reaches a total of number of points to graduate and win the game. In an embodiment of the invention, 225 points are needed to graduate.

Both knowledge and luck are needed to win the game. Luck is inherent in the spinner and the drawing of the cards, while knowledge of the various subjects is required in order to answer the wide variety of possible questions.

The board game 20 simulates an active school setting and a physical structure of a school environment. The board game is an educational game that provides associated questions and answers that are taught in school systems nationally.

Each school subject and space on the board represents a classroom setting. The names of the teachers imprinted on each space represent a physical teacher and associated classroom.

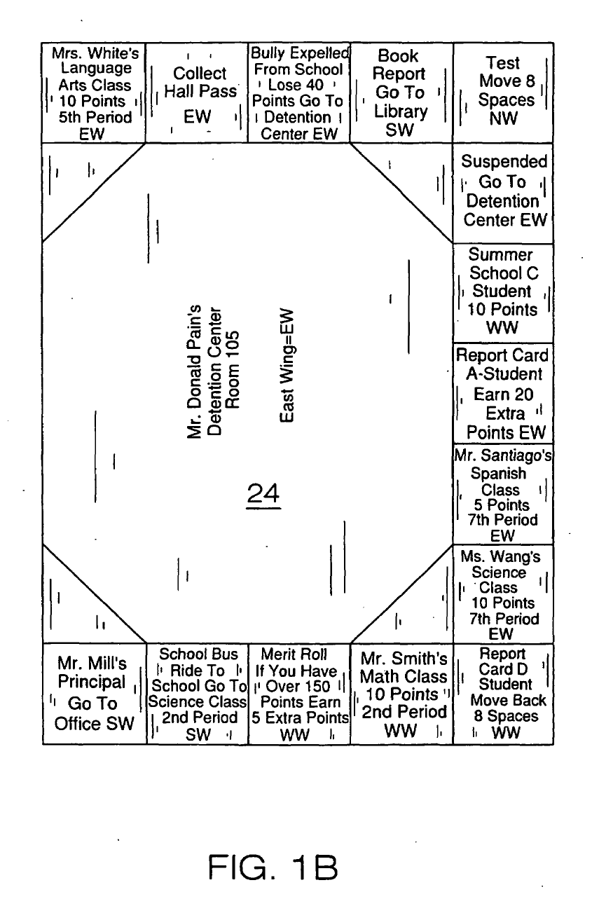

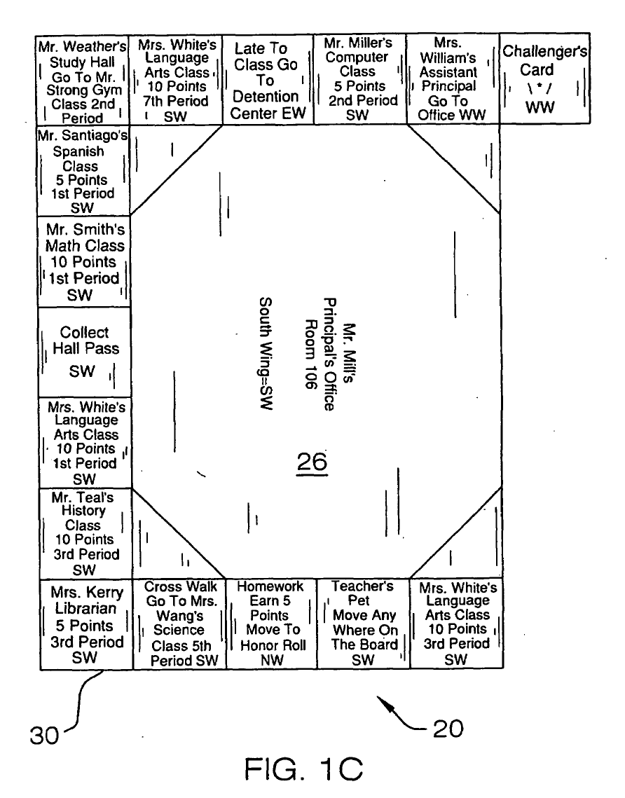

The numbers imprinted on each of the spaces, shown in FIGS. 2-3 represent a required number of points a student can earn for each associated space or subject.

In one embodiment of the invention the points range from 0, 5, 10 and 20 points. Each subject has a card with questions that are placed on an associated Class Monitor's Work Station that corresponds with questions and answers on the board game. The questions are imprinted on the back of Hall Pass flash cards that include clues to answers associated with the questions. The clues are defined by numbers and letters that may be deciphered using a Hall Pass deciphering code shown in FIG. 7 to decode the number or numbers that corresponds with a letter or letters of the English alphabet.

The dimensions of the Board Game 20 may be adapted to any suitable size wherein each of the spaces or squares on the board game may be easily read by each player of the game. Any dimensions of each game component including the board game map and associated squares, the spinner, the playing pieces, the class monitor workstation portion and associated flash cards are specified for illustrative purposes and should not be limited to the dimensions defined herein. The layout of the board game simulates a layout of a school.

In one embodiment of the invention, the dimensions of the board game may be about 10.25 inches in length by 6.75 inches wide. In another embodiment of the invention, the dimensions of the board game measures approximately 22 inches long and 19 inches wide.

However the dimensions may vary in accordance with a desired size of the map imprinted on the game.

The board game is divided into 63 spaces, as shown in more detail in FIGS. 1, 1A-1D, and 2, including class rooms and non-class rooms each formed into four quadrants forming a perimeter that defines a North, South, East and West Wing 22, 24, 26, 28 respectively of the simulative school.

In one embodiment of the invention, a total of 44 classrooms and non-classrooms form the Board Game Outer Perimeter. However, it is contemplated that the number of spaces on the board may vary and that the 63 representative spaces on the board are provided for illustrative purposes and may not be limited to the specific embodiments shown herein.

The Board Game is divided into a predefined number of spaces defining an inner and an outer perimeter. In one embodiment of the invention, the total number of spaces represent 63 rooms in a simulated school. Forty-four spaces are associated with classrooms that define the board game outer perimeter and 19 spaces are associated with rooms inside the inner perimeter associated with a maze that includes classrooms, staff offices and other rooms of interests that operate to advance the student player in various directions. The student may move in any desired direction of travel while inside the Maze. The student must make the best decisions as to coming out of the Maze 32.

In one embodiment of the invention, each classroom associated with the board outer perimeter and the maze forming an inner perimeter of the board has an associated color assigned thereto. For example, green may be used to represent the classrooms' outer perimeter and maze outer perimeter.

In a non-limiting embodiment of the invention, each number shown in FIGS. 1, 1A-1D, and 2 is associated with a particular space on the board. The classroom and non-classrooms are specified as follows:
1. 44. Home Room 0 Points
2. School Guard Go To Math Class 2^{ND} Period EW.
3. Mrs. Qualm's Music Class 5 points.
4. Mr. Miller Computer Class 5 Points
5. Auditorium move 10 spaces
6. Mr. Weather's Study Hall 0 Points
7. Mr. Santiago's Spanish Class 5 Points
8. Mr. Smith's Math Class 10 Points
9. Collect Hall Pass 0 Points
10. Mrs. White's Language Arts Class 10 Points
11. Mr. Teal's History Class 10 Points
12. Mrs. Kerry Librarian 5 Points
13. Cross Walk Go To Mrs. Wang's Science Class 5^{th} Period SW
14. Home Work earn 5 extra points Move to Honor Roll NW
15. Teacher's Pet move anywhere on the board
16. Mrs. White's Language Arts Class 10 Points
17. Mr. Smith Math Class 10 Points
18. Bus Stop Ride The Bus 22 Spaces NW
19. Mr. Teal's History Class 10 Points
20. Cutting Class Go To Detention Center EW 0 Points
21. Ms. Wang's Science Class 10 Points.
22. Lunch Period 0 Points Go To Language Arts 7^{TH} Period SW
23. Mr. Smith Math Class 10 Points
24. Class Clown Go To Mr. Donald Pain's Detention Center EW
25. School Transfer Go To Mr. Mill's Office SW
26. Mr. Teal's History Class 10 Points
27. B Student Move To Challengers Card WW
28. Report Card D Student Move Back 8 spaces WW
29. Ms. Wang's Science Class 10 Points
30. Mr. Santiago's Spanish Class 5 Points
31. Report Card A—Student Earn 20 extra points
32. Summer School C Student 10 Points
33. Suspended Go To Detention Center 0 Points
34. Test Move 8 Spaces NW
35. Book Report Go To Library
36. Bully Expelled From School Lose 40 Points Go to Detention Center EW
37. Collect Hall Pass EW
38. Mrs. White's Language Arts Class 10 Points
39. Failing Grades F Student Lose 30 Points Go To Mrs. William's Office WW
40. Mr. Teal's History Class 10 Points
41. New Student Go To Mr. Mill's Principal's Office EW
42. Ms. Wang's Science Class 10 Points.
43. Mrs. White's Language Arts Class. 10 Points
44. Late to Class. Go to Detention Center EW
45. Mr. Miller's Computer Class. 5 Points
46. Mrs. Williams's Assistant Principal. Go to Office WW
47. Challengers Card. Earn from 5, 10 or extra points
48. Mr. Mills' Principal Office Go to Office SW
49. School Bus Ride to School Go to Science Class 2^{nd} Period SW
50. Merit Roll. If you have 150 Points Earn 5 Extra Points
51. Mr. Smith's Math Class 10 points
52. Ms. Daniels Nurse Go to History Class 4^{th} period.
53. Honor Roll if you have over 200 Points Earn 10 Extra Points
54. Parents Conference Go to Home Room NW
55. Mrs. Qualm's Music Class 5 Points
56. Late to School Go to the Assistant Principal's Office
57. Mrs. Drake Guidance Counselor Go To Office SW
58. Ms. Wang's Science Class 10 points
59. Mr. Strong's Gym Class Earn 5 Points Go to Language Arts 5^{th} period EW
60. Mr. Santiago's Spanish Class 5 Points.
61. Talking in Class Go to the Assistant Principal's Office SW

In one embodiment of the invention, the associated length and width of each square is 0.5″ by 1.88″.

A plurality of cards used to play the game include: a Challengers Card, Class Monitor Cards, Hall Pass Flash Cards that each include questions and puzzle clues associated with each school subject.

In one embodiment of the invention, the challenger's cards and the class monitor's cards have length and width dimensions of 2″ by 3.5″.

There are sets of Hall Pass Flash Cards that have a predefined number of cards included in each set, wherein the flash cards that relate to various subjects in school including math, English, U.S. History, science, Spanish, music, and computer class. In one embodiment of the invention each set of cards for each related subject includes fifty cards.

The staff represented by playing pieces shown in more detail in FIG. 11 include Mr. Mills Principal 54, Mrs. Williams Assistant Principal 56, Mrs. Drake Guidance Counselor 58, and Mr. Donald Pain Detention Center 60. Hall Pass Staff. Each one of the faculty members are represented by a color that corresponds with their office and classroom on the board game.

All teachers have classes throughout the day, and each of the classes has been divided into periods ranging from 1 through 8. The class periods are located at the bottom of each class on the board game and the back of Flash cards questions and puzzle clues. The class periods are used by Mr. Mills Principal, Mrs. Williams Assistant Principal and Mrs. Drake the Guidance Counselor. When a student or participant is sent to one of the Staff Members office, the participant must select a card from the class monitor's workstation that relates to the office they were sent to. The student reads the information on the back of the card to the rest of the students playing the game and follows the direction on the back of the card. The class period is located on the back of each card relating to a particular subject area such as, but not limited to math, language arts, U.S. History, science, Spanish, music and computer class.

A wheel 70 having a spinner 74 and associated numbers 76 arranged in a circular pie-shaped pattern is provided to determine how many spaces on the board to advance. In an embodiment of the invention, the diameter of the wheel may be about 4 inches. Super Wheel.

In an embodiment of the invention, the spinner or “Super Wheel” is pie shaped and has associated numbers 1-10 imprinted thereon that allows students to spin an arrow and point to an associated number on the Hall Pass super wheel. The number that the arrow stops on determines the number of spaces the student will move their clone on the game board.

The Deciphering Code 46 is provided having a code that may be used by players to determine answers to questions asked using the flash cards.

In one embodiment of the invention a diploma card is provided.

A plurality of playing pieces representing students or “clones” in cylindrical shapes and staff members are provided, and are illustrated as for example, Mr. Mills, Mrs. Williams, Mrs. Drake and Mr. Donald Pain. As defined herein, the terms clones, students, participants, and players or variations thereof are used interchangeably.

In an embodiment of the invention, there are a plurality of figures in the form of miniature pawns varying in color that represent each student participant as they move through each class or any given room. They are called Clones 62, 64, 66, and 68 as shown in FIG. 12. Each student must select a clone.

In one embodiment of the invention, the clone playing pieces have a height of 1″ and a diameter of 0.25″, and the staff member playing pieces have a height of 1.5 inches and a diameter of 0.5″.

The student player must move their clone, representing the student player to that appropriate space and answer the question on the back of the card. If the correct answer is given, the student will earn those points and spin the wheel again to proceed on with the game. If the student cannot answer the question the student must remain on that space until their next turn. Then the student must spin the wheel and proceed on with the game.

The class monitor's workstation is adapted to receive a plurality of flash cards.

In an embodiment of the invention, the following pieces, rules, and general game play are as follows:

How to play the Game

Before the game begins the Class Monitor must do the following: A) Read the rules to all student or participants;

B) Open the Game Board and place it on a flat surface, preferably a table; C) Place Hall Pass Flash Cards Question and Clues on the Class Monitor's Work Station according to there corresponding numbers; D) Starting at Homeroom place all Clones on the Homeroom spaces and staff members on the Game Board according to their titles; and E) Arrange Hall Pass Deciphering Codes, Collect Hall Passes, Challengers Cards, Diplomas, Hall Pass Super Wheel and Hall Pass Answering Guide where they are easily accessible. The Class Monitor oversees the game making sure all rules are followed. Select Class Monitor (Use Class Monitor's Flash Cards).

Select Clones (Use Class Monitor's Flash Cards). Spin Hall Pass Wheel and Spinner or “Super Wheel”. Use Class Monitor's Flash Cards to determine which student or participants spins the wheel first. Player one spins the Hall Pass Super Wheel.

Move Clone to designated classroom or space on the virtual board. The student or participants must select a Hall Pass Flash Card from the Class Monitor's Work Station that relates to one of the following math, English, U.S. History and science, the library, Spanish class, music class and computer class and read the Question and solve the puzzle clue by using Hall Pass Deciphering Code. If the student or participants land on a non-classroom space, they must follow the directions on the associated space.

Each student or participant is given a time limit to solve the puzzle clue and answer a question. If the participant cannot answer the question in the time given, the student or participant forfeits their turn and the next student or participant spins the wheel and proceeds on with the game. If the correct answer is given, the student will earn the amount of points for that space and proceed with the game.

In one embodiment of the invention, the time limit given is 1.5 minutes per question. In another embodiment of the invention, less time, a 45 second time limit per question is given.

The number of students playing the game can vary from one to ten individual students or participants.

In another embodiment of the invention, teams of players may play. If there are 10 students playing the game, each of the 10 players will become a team. A team may include 20 to 30 students; a captain associated with each team selects 1 to 2 additional players. If the team captain selects one extra player each, then a total of 20 students or participants will play the game, if 2 players are selected by the team's captains, then a total of thirty players can play the game. This is called a Master Mind team. This will allow questions to be answered faster than would be answered by individual players.

The team earning the required number of points will graduate first. The remainder of the teams must continue until a second team finishes, allowing a third team to automatically take third place and the game is over. Each Master Mind team must use one clone to represent its team and any student or participants of that team can move the clone on the Hall Pass board game.

Points

The physical numbers on the spaces represents the number of points a student can earn for that space or subject ranging from 0, 5, 10 and 20 points. The questions are on the back of Hall Pass flash cards with clues to the answers.

Points may be earned in several ways. The first way is to answer a question correctly that is associated with a specified subject area, such as, in a non-limiting embodiment: math, U.S. History, science, language arts, Spanish, music, library, and computer class. Extra points may be earned for the following tasks: completed homework, earning all A's, correctly answering test questions, being an honor roll recipient, being on the merit roll, holding a Challenger's Card, and being the Teacher's Pet. Whatever class or space the student stops on will determine the number of points earned for that subject or space. On some spaces no points are earned.

In one embodiment of the invention, a total of 225 points are needed to graduate. Points average from 5, 10, to 20. Each student or student must keep and accurate record of their points. The class monitor also keeps a record of each student's points.

All points earned go toward graduation as long as the question is answered correctly. If the question is not answered correctly the student cannot earn any points or advance to the next class. The student must wait until their turn comes again and make an attempt to answer the same question.

Once the question is answered correctly, then the student is allowed to spin the Hall Pass Super wheel again and advance to the next class or space.

Traveling or Moving on the Board:

Hall Virtual Reality School is divided into four Wings including a North Wing, a South Wing, an East Wing and a West Wing. Several staff members' offices are in these wings. Mr. Mills' office is located in the South Wing and Mrs. Williams and Mrs. Drake's offices are located in the West Wing. The East Wing is Mr. Donald Payne's Detention Center and Commencement Hall is in the North Wing.

The abbreviations are as follows: North Wing is NW, South Wing is SW, East Wing is EW, and the West Wing is WW. Therefore when the student sees the abbreviation and class periods on back of the card they must go to that area and locate the class. The abbreviation is an indicator of the approximated area where the classes is located.

Hall Pass Virtual Reality School allows a student to locate their class with abbreviations of each of the four wings and class periods assigned to the teachers. At the bottom of each statement or question, there is a directive from one of the administrative faculty, when a student interacts with Mr. Mills Principal, Mrs. Williams Assistant Principal and Mrs. Drake's Guidance Counselor they must follow the direction on the back of the card.

The student will be sent to one of the class period's in the North Wing, South Wing, East wing or West Wing relating to math, English, U.S. History, science, library, Spanish, music and computer class.

Class Periods

Each teacher's class is divided into periods as follows: Mr. Miller's computer class has 2 periods; Mrs. Qualm's music class has 2 periods; Mr. Smith's math class has 4 periods; Mr. Santiago's Spanish class has 3 periods; Mr. Teal's history class has 4 periods; Mrs. Wang's science class has 4 periods; and Mrs. White's language arts class has 4 periods.

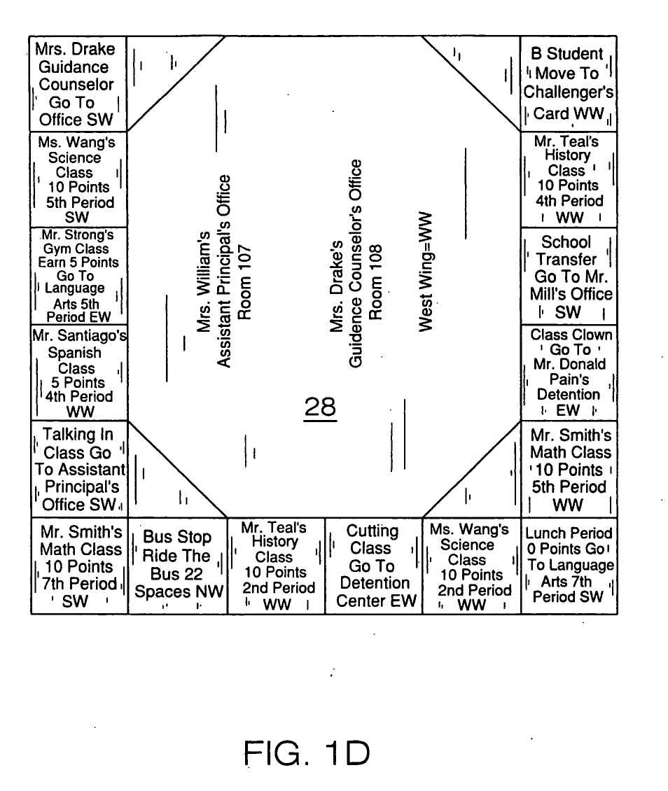

In one embodiment of the invention, shown in FIG. 4, the direction of traveling while playing the game is shown as follows: All students start at Home Room space. Each student player then moves to a next class after spinning the super wheel. When landing on a space, the student player selects an associated Hall Pass flash card from the Hall Monitor Work Station and then follows the associated directions on the back of the Hall Pass flash cards.

After spinning the Super Wheel, each student will travel in the direction of Mrs. Kerry, counter-clockwise from Mrs. Kerry, the Librarian travel to Lunch Period. There are no points to be earned during lunch period. From lunch period to the Test Questions and Answers, where a student can earn 5 more points. From Test Questions and Answers the student travels back to Home Room. This is the direction in which all students travel with the exception of moving in and out of the maze 32.

Making a Complete Cycle around the Game Board At the start of the game, Home Room is considered to be one large space. Once a complete cycle has been made, each one of the rooms is counted as a single space.

If the Arrow does not reflect a number large enough for the student to travel through Home Room and they have to stop in Home Room, the student receives a free spin.

Graduation.

One of the major goals in Hall Pass is for each student playing to graduate. Each student moves through the classrooms answering questions and earning points toward graduation. This provides incentive to each student to move through the classrooms to correctly answer questions and earn points toward graduation. In order for a student to graduate he or she must earn a total number of predefined points.

In one embodiment of the invention, a total of 225 points is needed to graduate. The first student securing the number of points required will graduate first. The second student earning the required number of points will graduate second and the third student acquiring the number of points will graduate third and the game is over.

The graduation ceremony takes place just before the game is over at Commencement Hall 22. The class monitor will give the student their diploma.

Diploma—When a student or participant accumulates 225 points or more, they will graduate and receive a diploma for attending School HallPass Virtual Reality.

The Class Monitor's Work Station is where all cards related to questions, clues, non-related classes and staff members are placed. This is where the class monitor oversees the game making sure the game is played by the rules and regulations, governing Hall Pass game board.

The Class Monitor will make sure the board game is set up properly including all materials connected with playing the game, including Hall Pass flash cards, Staff members, Clones, Hall Pass Deciphering Code, and the Hall Pass Super Wheel. Hall Pass Diplomas are passed out to the student graduating from the school at a Commencement Hall. The hall monitor keeps a record of points the student earned

The class monitor makes sure that all cards relating to questions and answers are on their proper square on the Class Monitor's work Station, that the student is keeping accurate records of their points and that all questions are answered correctly using the answer guide.

Additionally, the class monitor gives Diplomas to the students or participants graduating from Hall Pass Virtual Reality School.

Selecting the Class Monitor. The class Monitor is determined by using Hall Pass flash cards. There are 14 cards in each set with the name Hall Pass Flash Cards written on the face of the Cards. The back of the 10 cards are numbered 1 through 10. The eleventh card has no number. It has the name class monitor written on the back. The number of people playing the game determines how many cards is use out of the set. If 10 people are playing the game take out card number 10 and replace it with the class monitor's card. The cards must be shuffled and placed on a table with the name Hall Pass school facing up. Any student can shuffle the cards. Each student will select a card and the one selecting the card with the name class monitor on the back of it will be the class monitor. See FIG. 5.

The flash cards are a set of 14 cards with Flash Card and Class Monitor written of the face of each card. On the back of each of the first 10 cards is a number ranging from 1 to 10. Card number 11 will have the name Class Monitor on the back of it. These cards are used to determine which student will spin Hall Pass super wheel first. The cards are shuffled by any student and placed on a table with Hall Pass flash cards facing up. Each student will select a card. He or she must look on the back of their card and the student selecting the card with the words Class Monitor on the back will be the class monitor. When a card is selected the number on the back of the card determines the order in which each student will spin super wheel.

Each Staff Members names are written on the face of Flash Cards according to the subject they teach. The questions and puzzle clues and directive for Mr. Mills Principal, Mrs. Williams Assistant Principal and Mrs. Drake Guidance Counselor are on the back of each card. This also includes the Challengers Card, Collect Hall Pass, and Diploma for Graduation and the Class Monitors Card. Each card is numbered 1 through 14. Once the game is over, this will make it easier for the Class Monitor to place the cards back in order.

Follow these rules when selecting the class monitor. If one or two persons are playing the game, no class monitor is needed.

Each student or player can test their individual academic skills without the aid of a class monitor by following the rules of the board game, thereby enhancing the individual aptitude of the associated player.

If three or more students are playing the game, the following determines the number of Hall Pass Flash Cards to use in selecting the Class Monitor: If three are playing use 2 Cards, then insert the Class Monitors Card. If four are playing use 3 Cards, then insert the Class Monitors Card. If five are playing use 4 Cards, then insert the Class Monitors Card. If six are playing use 5 Cards, then insert the Class Monitors Card. If seven are playing use 6 Cards, then insert the Class Monitors Card. If eight are playing use 7 Cards, then insert the Class Monitors Card. If nine are playing use 8 Cards, then insert the Class Monitors Card. If ten are playing use 9 Cards, then insert the Class Monitors Card. See FIG. 5, Class Monitor's cards, 1 through 11.

More than one Class Monitor can participate depending on the number of students or participants playing the game, 2 to 3 Class Monitors can be used to keep an accurate flow of the game. If more than one Class Monitor is needed, the Class Monitor can select any student of choice.

After the game is over, all cards are collected by the class Monitor. Each Staff Members name is written on the face of Hall Pass Flash Cards according to the subject they teach. The questions and puzzle clues and directive for Mr. Mills Principal, Mrs. Williams Assistant Principal and Mrs. Drake Guidance Counselor are on the back of each card. This also includes the Challenger's Card, Collect Hall Pass, and Diploma for Graduation and the Class Monitors Card. Each card is number 1 through 14. Once the game is over, this will make it easier for the Class Monitor to place the cards back in order. See Class Monitor's Cards See FIGS. 5-6.

To begin the Game, each student or participant must select one card each from the Hall Pass Flash Cards 40 and the number on the back of the card selected will determine the order of spin. The student or participants with the lowest number will spin Hall Pass Super Wheel first. Players will spin in sequential order from the least to the greatest.

Hall Pass Super Wheel numbered 1-10, allows students to spin an arrow on the Hall Pass super wheel. When the student spins the wheel, whatever the number the arrow stops on determines the number of spaces the student or participant can move. The student must move their clone to that appropriate space and answer the question on the back of the card. If the correct answer is given, the student will earn those points and spin the wheel again to proceed on with the game. If the student cannot answer the question he or she must remain on that space until their next turn. Then he or she must spin the wheel and proceed on with the game.

Clones and Staff Members. Selecting clones are based on the order in which a student corresponding number is on the back of Hall Pass flash cards 1 through 11. The flash cards must be shuffled and each student will select a card and the student selecting the card with the number 1 on it will select their clone first. The rest of the students will follow in random order based on the number on the back of Hall Pass flash cards. See clones and staff members below, they are as followed.

In one embodiment of the invention, there are a plurality of components varying in size and color that represent staff members 54, 56, 58, 60 and students 62, 64, 66, 68, they are called clones. All clones have last name with the exception of Mr. Donald Pain. After the students select his or her clone, they must use their first name with the last name of the clone they select. If a student or participant selects Steinberg and his first name is Robert, the students or participants becomes Robert Steinberg and must use this name throughout the game. The rest of the students must follow the same rule, this does not include staff members. Before starting the game, all students or participants must place their Clone in Home Room and each staff members must be placed on the game board by the Class Monitor that corresponds with their names or titles.

The Hall Pass Deciphering Code consists of numbers and letters. The answers to questions are hidden in puzzle clues; the student or participants must become familiar with the number and letter arrangements of Hall Pass Deciphering Code. The answer to the questions related to an associated school subject area such as, but not limited to math, English, U.S. History, science, Spanish, music and computer class are hidden in each puzzle clue on the back of flash card. By using this information, the players will develop and expand their vocabulary, improve spelling, pronunciation, definitions, and comprehension.

Hall Pass Deciphering Code A through Z, is a table designed to help participants unscramble the correct answer hidden within the puzzle clues, break words up into syllables; and show how vowels and consonants interact with each other as they form words. Before using Deciphering Code all student and participants must become familiarize with the number and letter arrangements of Deciphering Code.

Deciphering Code A through Z, is a table designed to help the students or participants to unscramble the correct answer hidden within the puzzle clues, break words up into syllables; show how vowels and consonants interact with each other as they form words.

In an embodiment of the invention, there are 10 numbers on Hall Pass Deciphering Code; they are as follows, starting with 0 through 7. The digit 0 has a line under it, so it can be distinguished from the letter O. The number 1 has a line under it, so it can be distinguished from the capital letter I. Look at the ten numbers starting with 0, 3, 6, 9, 2, 5, 8, 1, 4 and 7. Using the English alphabet letters are placed next to numbers. Each number is assigned three letters with the exception of four numbers, which have two letters each. Below, the Deciphering Code arrangement is further explained. (0=A or K or U) (3=B or L or V) (6=C or M or W) (9=D or N or X) (2=E or O or Y) (5=F or P or Z) (8=G or Q) (1=H or R) d (4=I or S) (7=J or T).

Questions and Puzzle Clues are on the back of Hall Pass Flash Cards. Puzzle Clues are words concealed in combinations of numbers and letters. This allows the students or participants to visualize several possible word patterns, including prefixes and suffixes, and once the words have been decoded and the right answer is given, then he or she will earn points for that class.

The students or participants may create several words from the puzzle clues, but there is only one correct answer, so when reading the question or statements on the back of Flash Cards, be sure the player understands the question, so it will be easy for the player to insert the correct answer.

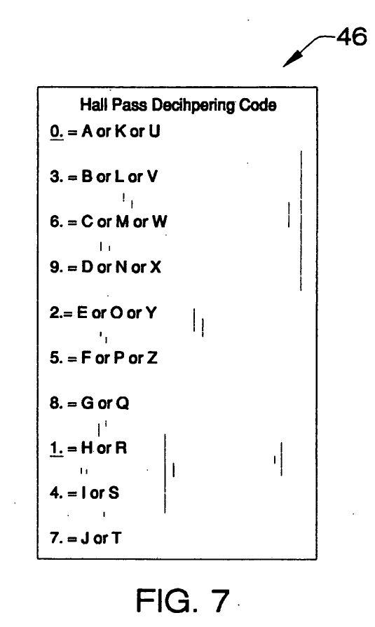

Solving Puzzle Clues. Read the statement on back of Hall Pass Flash Card below. Locate the puzzle clue on the back of Hall Pass Flash Card. Read the statement. See puzzle clue with numbers and letters. Remember each number is equivalent to a letter; notice the 0 represents the hidden letter, in order to determine the correct letter the students or participants must use Hall Pass Deciphering Code. See Hall Pass Deciphering Code FIG. 10. Now, locate the 0 in Hall Pass Deciphering code, the letters across from 0=A or K or U, therefore the students or participants has to insert the correct letter to form a word. Take out the O and insert the letter A, now the puzzle clue is Antarctica, try to pronounce the word, if you cannot figure it out, go to the next number which is (1). 1 represents the hidden letter. Locate the digit 1 in Hall Pass Deciphering code. Next to the digit 1 you'll see the letters H and R. Now insert the letter H and try to produce the word, if it doesn't formulate a word that you can pronounce, then insert the next letter which is R and R is the correct letter, now you have spelled the word Antarctica which is one of the 7 continents. Follow these directions with all puzzle clues.

Answers to Puzzle Clues. Answers to Question and Clues will be in Hall Pass Answering Guide.

Spaces on the board.

Home Room is 0 points. After all students or participants have been assigned a number from selecting a card to determine who spins and move first onto Hall Pass Board Game will start at Home Room. The students or participants with the Card numbered 1 on the back of it will spin first and whatever number the arrow stops on determines the number of spaces he or she will move on the board. All other student will follow in order based on the number that is on the back of the card selected. After spinning the wheel, the student must move their Clone the total number of spaces on the board and answer the question on the back of the Card, or follow the direction that is given on that space only. If the correct answer is given the students or participants must proceed on with the Game. If the correct answer is not given the students or participants must remain on that space until their turn comes again. If the correct answer is given, he or she will earn the amount of points on that space.

Each students or participant is given a specified time, such as 45 seconds or 1.5 minutes to answer a question, if he or she cannot answer the question in the time given, the student or participants forfeits their turn and the next students or participant must spin the wheel and proceed on with the game. As shown in FIGS. 1, 1A-1D, 2, Home Room is 1 large room comprising spaces (1), (2) and (44).

34. Challenger's Card WW While the game is in progress, if the students or participants cannot answer the question correctly within the time frame given, then the students or participants holding a Challenger's Card may intercede and make an attempt to answer the question. If the challenger answers the question correctly, then he or she will earn those points and move to that class or space of the students or participants that could not answer the question correctly. The challenger must turn their Challenger's Card in to the Class Monitor, spin Hall Pass Super Wheel and proceed on with the game. The students or a participant that is challenged must return to Home Room and start over. He or she will not lose any points and must wait until all students or participants have succeeded in spinning the Hall Pass Super Wheel.

If the challenger cannot answer the question correctly, the game will resume and the challenger will remain in their class until their turn comes again. The students or participants that could not answer the question correctly must remain in the same class until their turn comes again. The students or participants must answer the same question correctly before they are allowed to move to their next class. The second time around, if the students or participants answer the question correctly, he or she are allowed to spin Hall Pass Super Wheel and proceed on with the game. If he or she is still unable to answer the question, the students or participants must remain in that class until they are able to give the correct answer allowing the next students or participants to proceed on with the game.

The students or participants can have more than 1 Challenger's Card as long as they keep stopping on the Challenger's Card space. At this point, they have earned the right to collect more than one card. When the challenger challenges students or participants but cannot answer the question correctly or give the correct answer in the allotted time frame, he or she must surrender their Challenger's Card to the Class Monitor. The challenger can only use the card once. If the challenger holds more than 1 card, he or she cannot use another challenger's card to challenge the same students or participants. They must wait for another opportunity. Challenger's Card has (1) space. FIGS. 1, 1C, and 2, space (49) WW.

Follow the procedure specified below when landing on one of the following classes: Mrs. Qualm Music Class, Mr. Miller's Computer Class 5 Points, Mr. Santiago's Spanish Class, Mr. Smith's Math Class, Mrs. White's Language Arts Class, Mr. Teal's History Class 10 points, Cross Walk Go To Mrs. Wang's Science class 5^{TH} Period, or Ms. Wang's Science Class 10 Points 2^{ND} Period. Answers the question. If the question is answered correctly, spin again. Proceed on to the next class space.

If the question is answered incorrectly, wait until all students or participants have completed their turn and try again. A challenger holding a challenger's card may intercede and attempt to answer the question as discussed with respect to a Challenger's card.

Mrs. Qualm Music Class Earn 5 Points. Ms. Qualms has two Class Periods. See FIGS. 1, 1A, and 2, space (4), 3^{RD} Period NW, and space (57), 1^{ST} Period EW.

Mr. Miller's Computer Class 5 Points. Mr. Miller has two Class Periods. See FIGS. 1, 1A, 1C, and 2, space (5) 1^{ST} Period NW, and space (47) 2^{ND} Period SW.

Mr. Santiago's Spanish Class Earn 5 points. Mr. Santiago has two Class Periods. See FIGS. 1C, 1D, 2, space (8), 1^{ST} Period SW and space (62), 4^{TH} Period WW.

Mr. Smith's Math Class Earn 10 Points. Mr. Smith has four Class Periods. See FIGS. 1, 1B, 1C, 1D, and 2, Space (9), 1^{ST} Period SW, Space (18), 7^{TH} Period SW, class (24) Space 5^{TH} Period WW, and Space (53) 2^{ND} Period WW.

Mrs. White's Language Arts Class Earn 10 points 1^{ST} Period SW When stopping on this square, answer the question. Mrs. White has four Class Periods. Please See FIGS. 1, 1C, 1D, and 2, Space (11), 1^{ST} Period SW, space (17), 3^{RD} Period SW, Space (39) 5^{TH} Period EW and Space (45) 7^{TH} Period SW.

Mr. Teal's History Class 10 points. Mr. Teal has four Class Periods. Space (12), 3^{RD} Period SW, Space (20), 2^{ND} Period WW, Space (27) 4^{TH} Period WW, and Space (41) 8^{TH} Period NW. Please see FIGS. 1, 1A, 1C, 1D, and 2

Cross Walk Go To Mrs. Wang's Science class 5^{TH} Period (SW) South West. If the students or participants move onto this space, he or she must go to Mrs. Wang's Science Class 5^{TH} Period inside of the Maze and answer the question. Cross Walk has (1) space. See FIGS. 1, 1C, and 2, space (14) SW.

Ms. Wang's Science Class 10 Points 2^{ND} Period. Mr. Wang has four Class Periods. See FIGS. 1A, 1B, 1D, and 2, spaces (22) 2^{ND} Period WW, (30) 7^{TH} Period EW, (43) 1^{ST} Period NW, and (60) 5^{TH} Period SW.

If landing on either of the following spaces, follow directions as specified.

School Guard Go To Math Class 2^{ND} Period. When landing on this space, Go to Mr. Smith's Math Class 2^{ND} Period (EW) East Wing inside the Maze and answer Mr. Smith's question. If the students or participants answer the question correctly, he or she will earn 10 Points and must spin the Hall Pass Super Wheel and proceed on with the game. School Guard has (1) space. See FIGS. 1, 1A, and 2, space 3.

Auditorium Move 10 Spaces. When landing on this space, follow the directions by advancing 10 spaces. Start counting at the next square, Mr. Weathers Study Hall 0 Points, and stop on the Teacher's Pet space. Follow the instructions by moving anywhere on the Board. If the students or participants select a class to move to, they must answer the question and if the question is answered correctly, they must proceed on with the game. If the correct answer is not given, the students or participants forfeit their turn and the next student's or participant's turn becomes available. If the student stops on any space that gives extra points, the student will earn those points, spin the wheel again and proceed on with the game. The students or participants can be challenged by anyone holding a Challenger's Card if they cannot give the correct answer. Auditorium has (1) space. See FIGS. 1, 1A, and 2, space (6) SW.

Mr. Weather's Study Hall 0 points Go To Mr. Strong's Gym Class 2^{ND} Period. When landing on this space, the students or participants will earn 5 points. There are no questions to answer. He or she must spin Hall Pass Super Wheel and continue on with the game. The students or participants cannot be challenged by anyone holding a Challenger's Card while in Mr. Strong's Gym Class. Mr. Strong has (1) Class Periods. FIGS. 1, 1A, and 2, space (61), 5^{TH} Period EW.

Collect Hall Pass Earn 0 points. When landing on this space, no points are earned. This card allows the students or participants to leave any class or space of choice. For example, if the students or participants move onto Mr. Smith's Math Class Earn 10 Points and if he or she cannot answer the question correctly, he or she can ask to be dismissed from that class or the students or participants can decline to answer that question and select another space or class to move to with the exception of any space giving extra points. The students or participants do not have to spin the wheel when moving to your class of choice. After selecting the class of choice, the students or participants must answer the question or follow the directions on that space and proceed on with the game. When the students or participants select and move to their space or class of choice, he or she must surrender their hall pass to the Class Monitor or place it back on the Class Monitor's Board. This card will allow the students or participants to get out of Mr. Donald Pain's Detention Center. If the students or participants land on Mr. Donald Pain's Detention Center, he or she must surrender their Hall Pass and go to Home Room and spin Hall Pass Super Wheel. He or she must move to the next space or class and answer the question or follow the directives on the back of the card. The students or participants can have more than 1 Hall Pass and they can use one after another or at any given moment. Collect Hall Pass has two spaces. See FIGS. 1, 1B, and 2, space (10) SW and space (38) EW.

Miss. Kerry Librarian Earn 5 Points 3^{RD} SW. When going to the Library, the students or participants must select a book that is represented by a card on the Class Monitor's workstation. The books and card are related to one subject Math, English, U.S. History, Science, Library, Spanish, Music and Computer class. After selecting one of the cards, answer the question and if the question is answered correctly, he or she can spin again and move to the next class. If an incorrect answer is given, he or she must remain in the Library until their turn comes again. The students or participants do not lose any points already earned. He or she can still be challenged by students or participants' holding a Challenger's Card. Miss Kerry is assigned to the Library. See FIGS. 1, 1C, and 2 space (13) 3^{RD} Period SW.

Home Work Earn 5 Extra Points Move To Honor Roll. The students or participants have earned 5 points. There are no questions to answer. He or she must go directly to Honor Roll. If the students or participants have over 200 points or more, they will earn 10 points. There are no questions to answer. He or she must spin Hall Pass Super Wheel and proceed on with the game. If the students or participants do not have 200 points or more, they cannot earn the 200 points. He or she must proceed on with the game by spinning the wheel and moving to their next class or alternative class. Home Work has (1) space. FIGS. 1, 1C, and 2, space (15) SW.

Teacher's Pet Move anywhere on the Board. When landing on this space, the students or participants do not have to spin Hall Pass Super Wheel to leave the Teacher's Pet space. He or she can move to any class or space of choice. They do not have to answer any questions after moving to the next class or space. Once the students or participants move to the class or space desired, he or she earns those points and must spin the wheel again and proceed on with the game. They cannot be challenged by anyone holding a Challenger's Card. Teacher's Pet has (1) space. Please See FIGS. 1, 1C, and 2, space (15) SW.

Bus Stop Ride The Bus 22 Spaces NW. When landing on this space, the students or participants will not earn any points. He or she must count 22 spaces and stop on Mr. Teal's History Class and answer his question and proceed on with the game. If he or she cannot answer the questions, they must remain in that class until their turn comes again. He or she can be challenged by any students or participants holding a Challenger's Card. Bus Ride has (1) space. See FIGS. 1, 1D, and 2, space (19) NW.

Cutting Class Go to Detention Center. When moving onto this space, the students or participants must go directly to Mr. Donald Pain's Detention Center. They do not earn or lose any points. There are two ways to get out of the Detention Center. First, if the students or participants have a Collect Hall Pass Card, this will allow the students or participants to leave the Detention Center and they must return to Home Room and start over again. They must turn their Hall Pass into the Class Monitor. Second, if the students or participants are without a Collect Hall Pass, they must answer one of the questions related to Language Arts, Math, History or Science. If the question is answered correctly, they have permission to leave and must return to Home Room and start over again. If they cannot answer the question correctly, they must remain in the Detention Center until they can answer the question and try when their turn comes again. They cannot be challenged by anyone holding Challenger's Card. Cutting Class has (1) space. FIGS. 1, 1D, and 2, space (21) SW.

Lunch Period 0 Points Go To Language Arts 7^{th} Period (SW) South Wing When stopping on this space, no points are earned or lost. The students or participants must go to Language Arts class 7^{TH} period (SW) South Wing and answer Mrs. White's question, spin the wheel again and proceed onto the next class or space. The students or participants must answer the question or follow the directions on that space. If the students or participants cannot answer the question, they must remain there until all students or participants have had a turn. The students or participants can be challenged by anyone holding a Challenger's Card. Lunch Period has (1) space. See FIGS. 1, 1C, and 2, space (23), 7^{TH} Period SW.

Class Clown Go to Mr. Donald Pain's Detention Center (EW) East Wing. When moving onto this space, the students or participants must go directly to Mr. Donald Pain's Detention Center. They do not earn or lose any points. There are two ways to get out of the Detention Center. First, if the students or participants have a Collect Hall Pass Card, this will allow the students or participants to get out of the Detention Center and he or she must return to Home Room and start over again. They must turn their Hall Pass into the Class Monitor. Second, if the students or participants are without a Hall Pass, they must answer one of the questions related to English, Math, History or Science. If the question is answered correctly, they have permission to leave and must return to Home Room and start over again. If they cannot answer the question correctly, they must remain in the Detention Center until they can answer the question. They cannot be challenged by anyone holding Challenger's Card. Class Clown has (1) space. Please See FIGS. 1, 1C, and 2, space (25) WW.

School Transfer Go To Mr. Mill's Office (SW) South Wing. When landing on this space, go directly to Mr. Mill's Office. Read the question and follow the directions on the back of the Hall Pass Flash Card. You do not lose any points earned. You cannot be challenged by anyone holding a Challenger's Card. School Transfer has (1) space. See FIGS. 1, 1D, and 2, space (26) WW.

B Student Move To Challenger's Card (WW) West Wing. When stopping on this space, the students or participants must move directly to the Challenger's Card space and collect a Challenger's Card. He or she earns no points. He or she must spin Hall Pass Super Wheel and proceed on with the game. Then advance 10 spaces starting with Report Card and stopping on Collect Hall Pass. The students or participants must Collect a Hall Pass and spin the wheel again to proceed onto the next space and answer the question or follow the directions on that space. B-Student has (1) space. See FIGS. 1, 1D, and 2, class (28) WW.

Report Card D Student Move Back 8 Spaces WW. When stopping on this space, the students or participants must move back 8 spaces and start counting at the space B Student Move To Challenger's Card. The students or participants must move 8 spaces back until he or she reaches the space Cutting Class Go To Detention Center. Then, he or she must go directly to Mr. Donald Pain's Detention Center. If they have a Hall Pass or Challenger's Card, the students or participants must surrender both Cards to the Class Monitor. However, if the students or participants have a Hall Pass, he or she can come out of Mr. Donald Pain's Detention Center. They do not have to answer any questions. Their only requirement is to go back to Home Room. In order to come out of the Detention Center, the students or participants who do not have a Hall Pass must answer a question related to Language Arts, Math, History or Science. If the question of choice is answered correctly, they must go to Home Room and spin Hall Pass Super Wheel and proceed on with the game. If they cannot answer the question, they must stay in the Detention Center until they can answer the question. They cannot be challenged by anyone holding a Challenger's Card. Report Card D Student Move Back 8 Spaces has (1) space. FIGS. 1, 1B, and 2, space (29).

Report Card A-Student Earn 20 Extra Points EW. When stopping on this space, the students or participants earns 20 extra points. He or she must spin the wheel again and proceed to the next space or class and answer the question or follow the directions on that space. If they cannot answer the question correctly, the students or participants must remain in that class or space until they can give the correct answer. The students or participants holding a Challenger's Card can challenge the students or participants if the correct answer is not given. Report Card A—Student Earn 20 Extra Points. See FIGS. 1, 1B, and 2, space (32) EW.

Summer School C Student 10 Points. When stopping on this space, the students or participants is in Summer School. In order to come out of Summer School, the students or participants must answer a question related to Language Arts, Math, History, or Science. If the correct answer is given, they will earn 10 extra points. He or she must spin Hall Pass Super Wheel and proceed on with the game. If the correct answer is not given, he or she forfeits their turn and must wait until all of the students or participants have completed their turns. The students or participants must answer the same question and if they give the correct answer, they earn 10 extra points and must spin Hall Pass Super Wheel and proceed on with the game. While the students or participants are in Summer School, he or she cannot be challenged by any students or participants holding a Challenger's Card. Summer School C Student has (1) space. See FIGS. 1, 1B, and 2, space (33) EW.

Suspended Go to Detention Center. When moving onto this space, the students or participants must go directly to Mr. Donald Pain's Detention Center. They do not earn or lose any points. There are two ways to get out of the Detention Center. First, if the students or participants have a Hall Pass, this card will allow the students or participants to get out of the Detention Center and he or she must return to Home Room and start over again. They must turn their Hall Pass into the Class Monitor. Second, if the students or participants are without a Hall Pass, they must answer one of the questions related to English, Math, History or Science. If the question is answered correctly, they have permission to leave and must return to Home Room and start over again. If they cannot answer the question correctly, they must remain in the Detention Center until they can answer the question. They cannot be challenged by anyone holding a Challenger's Card. Suspended Go to Detention Center has (1) space. See FIGS. 1, 1B, and 2, space (34) EW.

Test Move 8 Spaces (NW) North Wing. When landing on this space, the students or participants must move 8 spaces on the board because they have a test in Ms. Wang's Science Class. The students or participants must answer the questions related to Science only. If the correct answer is given, they'll earn 10 points and must spin Hall Pass Super Wheel and proceed on with the game. If the correct answer is not given, the students or participants must remain on that space until their turn comes again. The students or participants can be challenged by any students or participants holding a Challenger's Card. Test Move 8 Spaces (NW) North Wing has (1) space. See FIGS. 1, 1B, and 2, space (35) EW.

Book Report Go To Library (SW) South Wing. When landing on this space, go directly to the Library. The students or participants must select a book. The book is related to one of the four subjects such as Math, History, English, or Science. After selecting one of the subjects, he or she must answer the question. If the correct answer is given, they will earn 5 points and must spin Hall Pass Super Wheel and proceed on with the game. If an incorrect answer is not given, the students or participants must remain on that space until their turn comes again. He or she does not lose any points already earned. The students or participants can still be challenged by any students or participants holding a Challenger's Card. Book Report Go To Library has (1) space. FIGS. 1, 1B, and 2, space (36) EW.

Bully Expelled From School Lose 40 Points Go To Detention Center EW. If the students or participants land on the Bully's space, the students or participants is expelled from school. He or she must go to the Detention Center. The students or participants will forfeit 40 points. The students or participants are expelled from Hall Pass Virtual Reality School for 2 weeks. The students or participants are to stay in the Detention Center for 2 weeks. Two weeks is equivalent to 5 minutes. Therefore, he or she will remain out of the game for 5 minutes and after 5 minutes; he or she must ask the Class Monitor if he or she can return to school. If the Class Monitor replies yes, then the students or participants are officially allowed back in Hall Pass Virtual Reality School. Then the students or participants have learned their lesson and will keep all of their points and return to Home Room and start all over again. Bully Expelled from School Lose 40 Points Go to Detention Center has (1) space. See FIGS. 1, 1B, and 2, space (37) EW.

Failing Grades F Student Lose 30 Points Go To Mrs. Williams Office WW. When landing on this space, the students or participants will lose 30 points. He or she must go directly to Mrs. William's Assistant Principal's Office (SW) South West, select a card and follow directions. If the students or participants have a Hall Pass or Challenger's Card, the students or participants must surrender both cards to the Class Monitor and spin Hall Pass Super Wheel and proceed on with the game. After proceeding to the next class, if the students or participants cannot answer the question correctly, he or she can still be challenged by any students or participants holding a Challenger's Card. Failing Grades F Student Lose 30 Points Go To Mrs. Williams Office WW has (1) space. See FIGS. 1, 1A, and 2, space (40).

New Student Go To Mr. Mill's Principal's Office (EW) East Wing. When stopping on this space, the students or participants will not earn any points. He or she must go directly to Mr. Mill's Principal's Office, select one of his cards, read the directions and proceed on with the game. He or she cannot be challenged by any students or participants holding a Challenger's card. New Student Go To Mr. Mill's Principal's Office has (1) space. See FIGS. 1, 1A, and 2, space (42) EW.

The Maze consists of 19 spaces and classes. Each space or class represents a Class Room, Staff Office and/or Directives.

Entering the Mazes.

As shown in FIGS. 1, 1A-1D, and 3, there are 19 classrooms, non-classrooms, and offices that define the inner perimeter called the Maze. All classrooms correspond with teachers and their names as well as academic subjects and alternative subjects. The student can only enter the Maze through designated rooms. Once the students or participants enter the Maze, they must follow all rules and directions for each individual teacher. While inside the Maze, the student can move in any direction of choice, they can turn left or right at the Challenger's Space, they can move forward or backwards or move in one direction until they exit. When a student moves onto a non-classroom space they must follow the directions on that space.

The Students or Participants can enter the Maze at the following designated Rooms:

### 3. School Guard Go To Math Class 2^{ND} Period EW.

7. Mr. Weather's Study Hall Mrs. Go To Mr. Strong Gym Class 2^{ND} Period SW.
14. Cross Walk Home Work Go To Mrs. Wang's Science class 5^{TH} Period SW.
15. Home Work Go To Mrs. Wang's Science class 5^{TH} Period

### 16. Teachers Pet Move Anywhere On The Board

### 23. Lunch Period 0 Points Go To Language Arts 7^{TH} Period SW.

25. Class Clown Go To Mr. Donald Pain's Detention Center
26. School Transfer Go To Mr. Mill's Office SW

### 28. B Student Move To Challenger's Card WW

40. Failing Grades F Student Lose 30 Points Go To Mrs. William's Counselor's Office WW
New Student Go To Mr. Mill's Principal's Office EW

Exiting the Maze.

There are several ways to exit the Maze as follows: 7. Exiting at Mr. Weather's study Hall, turn and move in the direction of Mr. Santiago's Spanish Class and Mrs. Kerry Librarian. There are no moves backwards in the direction of Home Room. A stop is made on a designated space number 1 through 10 that corresponds with the class or other rooms of interests. Questions are answered in accordance with directions on the back of flash cards.

Exiting at Mr. Smith's Math Class, turn and move in the direction of Bus Stop Ride The Bus 22 Spaces NW and Lunch Period. There are no moves backwards in the direction of Mrs. Kerry Librarian. The student stops a designated numbered space 1 through 10 that corresponds with the class or other rooms of interests and answers an associated question or follows the direction on the back of Flash cards.

3. Exiting at Report Card D Student Move Back 8 Spaces, turn and move in the direction of Ms. Wang's Science Class 10 points 7^{TH} period. Move in the direction of Test Move 8 Spaces NW. The student moves backwards in the direction of Lunch Period and alternative subjects. Stop on the designated number 1 through 10 that corresponds with the class or other rooms of interests and answer question or follow the direction on the back of Hall Pass Flash Cards.

40. Exiting at Failing Grades F Student Lose 30 Points Go To Mrs. William's Office WW, turn and move in the direction of Mr. Teal's History Class 10. Points and Home Room, The students or participants cannot move backwards in the direction of Test Move 8 Spaces NW. Stop on the designated number 1 through 10 on one of the eleven Hall Pass cards that corresponds with the class or other rooms of interests and answer question or follow the direction on the back of Hall Pass Flash Cards.

Staff Member's and Directives may take the students or participants out of the Maze.

Other Ways to Exit the Maze:

Directives: To exit the Maze, a student player follows the direction on the back of a Staff Member's Card and alternative classes, wherein the directions are as follows:
a. Mr. Mills' Principal Office,
b. Mrs. Williams' Assistant Principal,
c. Mrs. Drake Guidance Counselor,
d. Parents Conference Go To Home Room,
e. Late To Class Go to Detention Center,
f. Late To School Go To Assistant Principal's Office,
g. Talking in Class Go To Assistant Principal's Office,
h. School Bus Ride To School Go To Math 1^{ST} Period SW,
i. Challenger's Card, and
j. Mrs. Daniels Nurse Go To Mr. Teal's History 4^{TH} Period SW

The classes having special directives include Late to Class Go to Detention Center (EW) East Wing, Mrs. William's Assistant Principal Go to Office (WW) West Wing, Mr. Mill's Principal Go to Office SW, School Bus Ride To School Go To Science Ms. Wang's Science Class 2^{ND} Period (SW) South Wing, Merit Roll if you have 150 Points Earn 5 Extra Points WW, Ms. Daniel's Nurse Go To Mr. Teal's History Class 4^{TH} Period, Honor Roll Earn if you have 200 Points Earn 10 Extra Points, Parents Conference Go to Home Room, Late to School Go to Assistant Principal's Office (WW) West Wing, Mrs. Drake's Guidance Counselor Go to office (SW) South Wing, Mr. Strong's Gym Class Earn 5 Points Go To Language Arts 5^{TH} Period (EW) East Wing. More particularly, the directives associated with each of the spaces in the Maze are specified as follows:

Late to Class Go to Detention Center (EW) East Wing. When moving onto this space, the students or participants must go directly to Mr. Donald Pain's Detention Center. They do not earn or lose any points. There are two ways to get out of the Detention Center. First, if the students or participants have a Hall Pass, this card will allow the students or participants to get out of the Detention Center and he or she must return to Home Room and start over again. The students or participants must turn their Hall Pass into the Class Monitor. Second, if the students or a participant is without a Hall Pass, he or she must answer one of the questions related to English, Math, History or Science. If the question is answered correctly, they have permission to leave and must return to Home Room and start over again. If the students or participants cannot answer the question correctly, he or she must remain in the Detention Center until he or she can answer the question. The students or participants cannot be challenged by anyone holding Challenger's Card. Late to Class Go to Detention Center has (1) space. See FIGS. 1, 1C, and 2, space (46) EW.

Mrs. William's Assistant Principal Go to Office (WW) West Wing. When stopping on this space, no points are earned. The students or participants must go directly to the Assistant Principal's Office and select a card and follow the directions on the back of the card. The Assistant Principal deals with all the negative aspects such as being suspended from school, sending the students or participants to the Detention Center, taking away points, etc. Mrs. William's Assistant Principal Go to Office has (1) office. See FIGS. 1, 1C, and 2, space (48) WW.

50. Mr. Mill's Principal Go to Office SW. When stopping on this space, no points are earned or lost. The Principal deals with all aspects of the school, such as Graduations, Diplomas, Field Trips, and Parent/Teacher Conferences, etc. When stopping on this space, the students or participants must go to Mr. Mill's office and follow the directions on the back of the card. Mr. Mill's Principal Go to Office has (1) office. See FIGS. 1, 1B, and 2, space (50) SW.

School Bus Ride To School Go To Science Ms. Wang's Science Class 2^{ND} Period (SW) South Wing. When stopping on this space, there are no questions to answer and no points to earn. The students or participants must go directly to Ms. Wang's Science Class 2^{ND} Period and select a card related to Science only. The students or participants must answer the question on the back of card, and if he or she gives the correct answer, he or she will earn 10 points and must continue on with the game. If the question is not answered correctly, the students or participants must wait until all students or participants have completed their turn and try again. The students or participants holding a Challenger's Card can intercede. If the challenger answers the question correctly, he or she earns those points and the students or participants that could not answer the question must return to Home Room and start over again. School Bus Ride To School Go To Science Ms. Wang's Science Class 2^{ND} Period has (1) space. See FIGS. 1, 1B, and 2, space (51) SW.

Merit Roll if you have 150 Points Earn 5 Extra Points WW. When stopping on this space, there are no questions. The students or participants can earn 5 extra points. In order to earn extra points, the students or participants must have 150 points or more. If he or she has 150 points or more, he or she earns 5 extra points and must spin the wheel again and proceed on with the game. If he or she doesn't have 150 points or more, the students or participants must spin the wheel again, proceed onto the next class or space and answer the question or follow the directions on the back of card selected. They cannot be challenged by anyone holding a Challenger's Card. Merit Roll if you have 150 Points Earn 5 Extra Points has (1) space. FIGS. 1, 1B, and 2, space (52) SW.

54. Ms. Daniel's Nurse Go To Mr. Teal's History Class 4^{TH} Period. When stopping on this space, there are no questions to answer and no points to earn. The students or participants must go directly to Mr. Teal's History Class 4^{TH} Period and select a card related to History only. The students or participants must answer the question on the back of the card. If he or she gives the correct answer, the students or participants earn 10 points and must continue on with the game. If the question is not answered correctly, the students or participants must wait until all students or participants have completed their turn and try again. The students or participants holding a Challenger's Card can intercede. If the challenger answers the question correctly, he or she earns those points and the students or participants that could not answer the question must return to Home Room and start over again. Ms. Daniel's Nurse Go To Mr. Teal's History Class 4^{TH} Period has (1) space. FIGS. 1, 1A, and 2, space (54) EW.

Honor Roll Earn if you have 200 Points Earn 10 Extra Points. When stopping on this space, there are no questions. The students or participants can earn 10 extra points. In order to earn extra points, the students or participants must have 200 points or more. If he or she doesn't have 200 points or more, the students or participants must spin the wheel again and proceed onto the next space or class and answer the question or follow the directions on the back of the card. If he or she has 200 points or more, the students or participants earn 10 extra points and must spin the wheel again and proceed on with the game. Honor Roll has (1) space. FIGS. 1, 1A, and 2 space (55) EW.

Parents Conference Go to Home Room. When stopping on this space, there are no questions and no points are earned or lost. The students or participants must go to Home Room and spin Hall Pass Super Wheel and continue on with the game. He or she does not lose their turn to spin the wheel nor can he or she be challenged by any students or participants holding a Challenger's Card. Parents Conference has (1) space. See FIGS. 1, 1A, and 2, space (56) EW.

Late to School Go to Assistant Principal's Office (WW) West Wing. When stopping on this space, no points are earned. The students or participants must go directly to the Assistant Principal's Office, select one of the cards and follow the directions on the back of the card. Late to School Go to Assistant Principal's Office has (1) office. See FIGS. 1, 1A, and 2, space (58) EW.

Mrs. Drake's Guidance Counselor Go to office (SW) South Wing. When stopping on this space, no points are earned. The students or participants must go directly to the Guidance Counselor's Office, select one of the cards and follow the directions on the back of the card. The Guidance Counselor deals with the students or participants Grades, Class Schedules, Graduations, Parents, Colleges, Job Training, etc. Mrs. Drake's Guidance has (1) office. See FIGS. 1, 1D, and 2, space (59) WW.

Mr. Strong's Gym Class Earn 5 Points Go To Language Arts 5^{TH} Period (EW) East Wing. When stopping on this space, the students or participants will earn 5 extra points. He or she must go directly to Mrs. White's Language Arts Class 5^{TH} Period and answer the question. If the question is answered correctly, he or she must spin Hall Pass Super Wheel and proceed on to the next class or space. If the question is not answered correctly, he or she must wait until all students or participants have completed their turn and try again. The students or participants are subject to be challenged by any students or participants holding a Challenger's Card. Mr. Strong's Gym Class has (1) class. See FIGS. 1, 1D, and 2, space (61) WW.

Talking in Class Go to Assistant Principal's Office SW. When stopping on this space, no points are earned. The students or participants must go directly to the Assistant Principal's Office, select a card and follow the directions on the back of the card. Talking in Class has (1) space. See FIGS. 1, 1D, and 2, space (63) WW.

The following are examples of statements that may be on the back of Mr. Mill's Principal Flash cards:

Stop in my office next week and asked for the office secretary, she will have your transfer for you. Go to your next class Math 1^{ST} Period SW.

I was told your friend John wears a hearing aid. When there's a fire drill will you assist him? Go to your next class and answer Ms. Wang's question Science 7^{TH} Period WW.

The school bus you ride is having mechanical problems. Check with Mrs. Riley in the transportation department and she'll let you know what bus to take. Go to your next class Language Arts 3^{RD} Period SW.

Reminder. Next Monday is a National Holiday. There will be no school. Go to your next class History 8^{TH} Period NW

Since you're the school bus monitor, it's important to make sure all kids remain in their seats, especially when crossing the Chesapeake Bay. Go to your next class and answer question Music 3^{RD} Period NW.

Congratulations. Since you're an A student, I am recommending you for the Oliver Wendell Homes Scholarship Program. Go to the Library 3^{RD} SW.

Welcome to Virtual Reality School. Since you're new to our school, I would like to give you a list of the rules and regulation. If you have any questions see me. Go to your next class Language Arts 5^{TH} Period EW.

Your parent or parents' income must be within the state's guidelines for you to qualify for the school lunch program. Take this application home and have your parent or parents fill it out. Return it to me. Go to your next class Spanish 7^{TH} Period EW.

You have a 4.0 grade average. I am recommending you to the State Governor's office to be considered as an applicant for the United States Air Force Academy. Go to Computer class 1^{ST} Period NW.

These are some examples of statements that will be on the back of Mrs. William's Assistant Principal Flash Cards.

1. I heard you ran the winning touch down last Saturday. Is this true? If so, you're the number one running back in the state, why are you constantly talking in class? Go to Mr. Donald Pains Detention Center EW.

2. You have a 1.0 grade average and I m recommending you to be placed in a special education class. Go to lunch SW and follow the instruction on that space.

3. While on the field trip to Niagara Falls, you were told to stay in your seat. Since you disregarded the bus driver's rules, go to Bus Sop Ride The Buss 22 Spaces NW and answer question.

4. Why are you constantly running through the Halls, this is your 9^{th} warning. Go to Mr. Donald Pain's Detention Center EW.

5. Since you like to cut Class, you lose 20 points, go to Home Room NW and start over again.

6. You know the rules for fighting in class, since you disregarded the school's rules, you must bring your parents to school. Go to Parents Conference NW and follow the directions.

7. You were told not to cross in the middle of the street. Why is it so difficult for you to walk with the rest of the kids and let the School Guard assist all of the kids in crossing the streets? Go To School Guard and follow the directions.

8. At 3:00 PM next Wednesday a Military representative from the US Armed Forces will be here. Since you're seventeen and only in the eighth grade, you have been asked to attend? Go to your next class History 4^{TH} Period WW.

While several aspects have been presented in the foregoing detailed description, it should be understood that a vast number of variations exist and these aspects are merely an example, and it is not intended to limit the scope, applicability or configuration of the invention in any way. Rather, the foregoing detailed description provides those of ordinary skill in the art with a convenient guide for implementing a desired aspect of the invention and various changes can be made in the function and arrangements of the aspects of the technology without departing from the spirit and scope of the appended claims.

What is claimed is:

1. An educational board game comprising:
a map imprinted on a game board that simulates an experience of a school including an operational structure, a physical layout and associated educational materials associated with the school.

2. The game of claim 1, wherein the map comprises:
a first set of squares representing a plurality of classrooms in a school; and
a second set of squares representing a plurality of non-classrooms associated with actions to be taken by players landing on the second set of squares.

3. The game of claim 2, wherein the first set of squares representing a plurality of classrooms in a school comprise:
movement spaces that cooperate to define paths around the school, wherein the movement spaces are imprinted with a classroom type and an associated teacher's name.

4. The game of claim 2, further comprising:
a maze formed from a plurality of a first and second set of squares respectively, wherein the maze is imprinted in criss-cross tee configuration and defines an inner perimeter of the school to specify actions that are taken when landing on each space within the maze.

5. The game of claim 1, further comprising:
a plurality of game pieces that advanced along the game board while playing the game;
a plurality of flash cards;
a spinner that operates to determine a number of spaces to advance on the game board; and
a class monitor workstation for administering associates rules of the game.

6. The method of claim 5, further comprises:
providing a plurality of question cards each having clues associated with the questions, wherein each of the questions on the cards are related to a particular subject area in school.

7. The game of claim 5, wherein the plurality of player pieces comprise:
at least one clone representing a student participant;
at least one staff member representing staff at a school; and
a class monitor representing a player participant that administrates rules associated with the game.

8. The game of claim 5, wherein the plurality of flash cards comprise:
a plurality of question cards each associated with a particular school subject.

9. The game of claim 8, wherein the question cards comprise questions relating to a school subject, wherein the school subject may be selected from math, English, history, science, Spanish, music, or computer skills.

10. The game of claim 5, further comprising:
a deciphering code encoded with a game cipher for assistance with answering questions associated with the plurality of flash cards; and
an answering guide that operates to provide answers to each of the questions associated with the plurality of flash cards.

11. An educational board game comprising:
a map imprinted on a game board that simulates an interactive school environment having
a first set of spaces that represents classrooms,
a second set of squares representing actions to be taken by the player of the game;
a wheel and spinner used to determine a number of spaces a player may advance each turn;
a plurality of flash cards including associated educationally related questions that are answered through use of a decipher code;
a decipher code;
a class monitor workstation that allows a class monitor to administer game rules; and
a diploma given to players upon earning a predefined number of points associated with the game.

12. A method of using an educational board game comprising:
providing a map imprinted on a game board that simulates an experience of a school including an operational structure, a physical layout and associated educational materials associated with the school; and
using the game to simulate an experience of a student in a school environment.

13. The method of claim 12, further comprising:
advancing a game piece associated with the board game to a specified location on the board game;
following instructions as illustrated on the school map when landing on the specified location;
earning points towards receiving a diploma while playing the game; and
receiving a diploma upon earning a predefined number of points.

14. The method of claim 13, further comprising:
using a class monitor to administer rules associated with the game.

15. The method of claim 12, wherein earning points towards graduation while playing the game comprises:
correctly answering one or more questions associated with a plurality of question flash cards, wherein each question flash cards is associated with a particular subject area taught in school.

16. The method of claim 15, further comprising:
using a deciphering code to correctly answer the one or more questions.
